(19) United States
(12) Patent Application Publication
(10) Pub. No.: US 2015/0052945 A1
(43) Pub. Date: Feb. 26, 2015

(54) Mounting Device with Mirror-Image Mounting Surfaces

(71) Applicants: Nick Paul Carter, Bellevue, WA (US); Bethany Bennett Carter, Bellevue, WA (US); Logan Bennett Carter, Bellevue, WA (US)

(72) Inventors: Nick Paul Carter, Bellevue, WA (US); Bethany Bennett Carter, Bellevue, WA (US); Logan Bennett Carter, Bellevue, WA (US)

(21) Appl. No.: 13/972,399

(22) Filed: Aug. 21, 2013

(51) Int. Cl. A44C 17/02; G05B 19/4097; F16M 11/02

(52) U.S. Cl. CPC A44C 17/02; F16M 11/02; G05B 19/4097
USPC 63/26; 248/346.03; 700/98

(57) ABSTRACT

The claimed invention is a mounting device for an object. The preferred embodiment is as a jewelry device or display device. The mounting device comprises supports and restraints whose surfaces correspond precisely to selected surfaces on the object. Mounting surfaces allow tolerance with regard to interfit with the object. In the jewelry industry, the result is that the interior surfaces of seats in a mounting are the mirror image of facets on a gemstone. This use of reflected geometry in a mounting provides benefits in manufacturing, setting, and usage of a finished article. The mounting may be constructed of one or more than one piece, and those pieces may be permanently or temporarily joined to form the mounting. The mounting may be manufactured by any of several methods subject to a skilled designer's preference, including but not limited to fabrication by manual process, computer-aided design and manufacturing, metal-powder. The preferred method disclosed with this invention utilizes computer-aided design and machining (CAD/CAM).

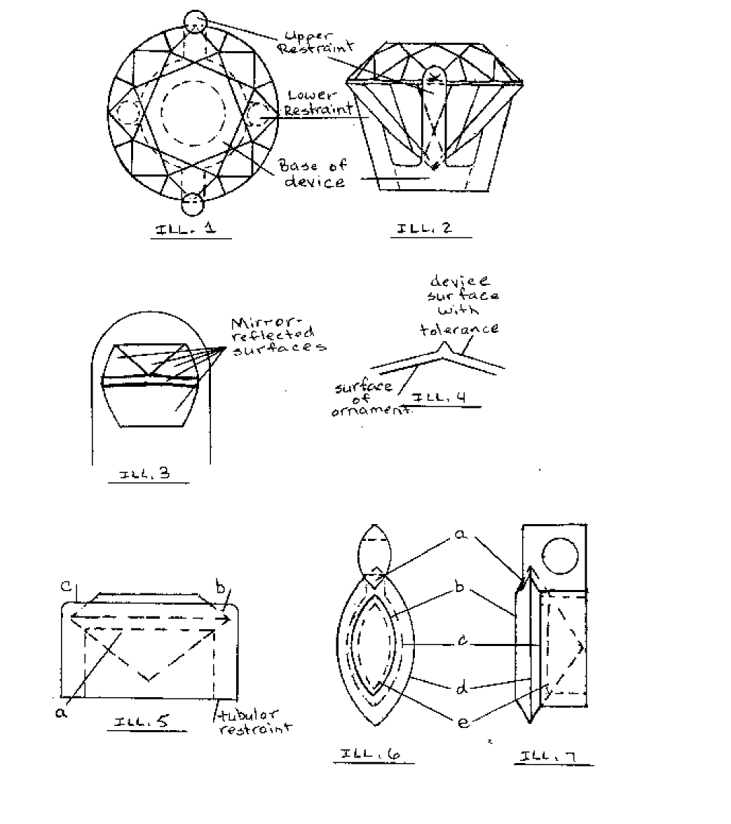

### CROSS-REFERENCE TO RELATED APPLICATIONS

This application claims the benefit of provisional application 61/693,060, “Device for holding ornamental objects,” filed Aug. 24, 2012

### STATEMENT REGARDING FEDERALLY SPONSORED RESEARCH OR DEVELOPMENT

Not applicable. This invention was not made under federally sponsored research or development.

### REFERENCE TO SEQUENCE LISTING/TABLE/COMPUTER PROGRAM LISTING COMPACT DISC

Not applicable. This invention does not require a sequence listing, table, or computer program.

### BACKGROUND OF THE INVENTION

This invention relates generally to a mounting for objects to be worn as jewelry or displayed for visual observation, and particularly to a mounting device in which the mounting surfaces correspond in shape and dimension to the surfaces of the contained object. Several terms from the industry of designing, manufacturing, and assembling display devices and articles of jewelry apply to this invention: setting refers to the process of installing and securing an object, such as but not limited to a gemstone, which may or may not be faceted or polished. A mounting is a fixture into which an object is installed and secured. A seat is a surface or collection of surfaces where the object contacts the mounting. The bottommost portion of the mounting, generally obscured by the object within the mounting, is the base of the mounting. Supports and restraints are points of contact between a mounting and an object which serve to contain an object within a mounting. A support is generally positioned below the widest perimeter of an object and serves to stabilize the object within a mounting. A restraint is generally positioned above the widest perimeter of an object and serves to secure the object within a mounting. A complete mounting uses a plurality of supports and restraints to contain an object. Examples of typical restraint and support mechanisms include prongs, channels, and bezels.

A prong is a rib- or claw-like member integral to the mounting. In plurality, prongs create a space which surrounds, contains, restrains, and supports the object and approximately reflects the shape of the object. Prongs are typically cut and/or bent to match the shape of the object, and then pressed against the object to set it securely in the mounting; a plurality of prongs fashioned into a mounting is referred to as a head. A channel is a space between vertical walls which supports opposite edges of an object. In a channel mounting, voids cut into the vertical walls secure an object; these voids are shaped to approximately match the contours of the object. A bezel is a rim or band which surrounds an object, generally at the object's largest perimeter, and holds it in place. In a bezel mounting, the object is generally secured by pressing the rim over the edge of the object.

The claimed invention addresses certain problems inherent to current technology. Specifically, for objects in mountings, the claimed invention: (1) reduces the risk of damage to objects caused by pressure applied during the setting process, (2) reduces the time required to complete a display piece or an article of jewelry, (3) provides a more secure mounting for an object, and (4) allows for increased visual observation of an object.

The claimed invention reduces the risk of damage incurred on the object during the setting process. In setting, an artisan applies sufficient pressure on the mounting to alter its shape and conform it to the shape of the object. This pressure positions the mounting against the object and secures the object within the mounting. Ideally, this pressure is applied on a plane parallel to a surface of the object. However, because the fit between the object and the mounting is approximate rather than exact, pressure may instead be applied at junctions between surfaces on the object, such as facet edges on a gemstone. Pressure applied at surface junctions during setting can cause damage to the object. The claimed invention fits the shape of the mounting to the shape of the object and allows tolerance in that fit, using mounting surfaces which are parallel to the surfaces of the object. Therefore, pressure applied during the setting process is distributed across surfaces rather than being concentrated at surface junctions. Thus, the claimed invention s benefits skilled industry workers by reducing the risk of damage during the setting process.

Prior inventions have also addressed the issue of the time and skill required to set an object in a mounting. U.S. Pat. No. 5,671,613, issued Sep. 30, 1997 to Hoover, et al. advanced the art with a setting having notched prongs, which provided skilled workers with an alternative to individually cutting each prong in a mounting. However, this approach can still result in pressure applied to a junction of surfaces. The present invention advances prior art by providing mounting surfaces which correspond geometrically to surfaces of the object, so that pressure is not applied to surface junctions.

The claimed invention benefits artisans by reducing the time required to complete the assembly of an article. Setting an object in a mounting based on current technology requires a skilled worker to take time for careful placement of the object within the mounting and for constant attention to ensure the object does not shift within the mounting during setting. The time required to complete the setting process increases directly with the number of contact points between the mounting and the object, as defined by the number of supports and restraints in the mounting. In a prong mounting, each prong is a point of contact. In a channel mounting, each void in a vertical wall is a point of contact. In a bezel mounting, points of contact are created as the worker presses the band over the edge of the object. Regardless of the mechanism used, the worker must prepare each point of contact to approximately reflect the shape of the object. Two time-related factors typically affect industry workers: (1) the time needed to develop the skill required to prepare a mounting, and (2) the time needed to assemble a mounting once that skill is acquired. The claimed invention reduces or eliminates both of these factors by using mounting surfaces that precisely correspond to the shape of the object. This reduces or eliminates the need for extensive preparation of points of contact by workers, and allows the object to rest in a more stable manner at the points of contact. Thus, the claimed invention can reduce the time required for industry workers to become proficient in setting an object, and can reduce the time required for a skilled industry worker to complete the setting process of an object.

There are devices in prior art which address the goal of simplifying the setting process. U.S. Pat. No. 4,392,289, issued Jul. 12, 1983 to Michael, devises a method of lost wax casting in which precious metal is cast around a gemstone which is preset into a wax, referred to in the industry as stone-in-place casting. This method achieves a finished article in fewer steps than other procedures, but still incurs risk of damage to the object during the casting process, and is difficult to use with some gemstones which cannot withstand the heat required in the casting process. Further, this method does not allow tolerance in the mounting and does not result in mounting surfaces within seats which mirror the surfaces of the object within the mounting. In contrast, the present invention allows tolerance as well as a precise fit relative to the object. The present invention may be produced with traditional casting methods, although this is not the preferred process. Because casting and setting are not done simultaneously, the present invention may be used with any gemstone.

The claimed invention improves the stability and security of a mounting, which are determined by how closely the shape of contact points reflect the shape of an object, and by the manner in which the surfaces of the mounting support the object. Planar support is safer and more secure than support provided by contact at surface junctions such as facet edges. Each point of contact in a mounting is critical because it is a structural element that helps ensure the stability and security of the mounting. When points of contact do not exactly match the shape of the object, it is more difficult to securely set in an object in a mounting. Either during the setting process or during normal usage, an object which is not securely positioned can to shift position within a mounting. This can lead to an object becoming loose within a mounting or falling out of the mounting, which can result in loss of or damage to an object, and such damage can result in significantly reduced value of an object. Damage can also occur if an article is dropped, because the points of contact can transfer impact pressure similar to that which occurs during setting. The claimed invention benefits industry workers and consumers by creating precisely matched mounting surfaces that improve the security and stability of mountings.

Other inventions in prior art also address the stability of mountings. U.S. Pat. No. 6,260,384, issued Jul. 17, 2001 to Mino et al., advanced the art by disclosing a jewelry setting with a faceted cavity. The present invention is distinguished from U.S. Pat. No. 6,260,384 in that the present invention is not limited to prong construction and uses mirror images with tolerance in the seat of the mounting rather than concentric rectangular openings.

The claimed invention increases the ability to visually observe an object. Objects chosen to be set in mountings or display stands are generally considered visually pleasing by their owners. The claimed invention improves on current mountings by requiring significantly less mounting material at each mounting mechanism, thereby increasing the portion of the object that is visible.

Other inventions in the prior art have addressed the visibility of a jewelry object. U.S. Pat. No. 1,211,240, issued Jan. 2, 1917 to Ryan, utilizes a single bezel around the girdle of a swinging gem on a pendant. Such a bezel requires pressure against the gemstone during setting, risking damage. The present invention matches the shape of the bezel interior to the shape of the object, ensuring that setting pressure is distributed across a plane rather than at a single point. U.S. Pat. No. 5,690,477, issued Nov. 25, 1997 to Haimoff devises an “invisible” method for setting gemstones. This method allows very high visibility of the object. However, in most invisible settings the object must be notched or grooved below the pavilion, which alters the original shape of the object, reducing the weight and therefore potentially the value of the object. The present invention offers high visibility of an object without requiring alteration of the object's shape. U.S. Pat. No. 5,974,831, issued Nov. 2, 1999 to Afuku et al, uses a single restraint and an aperture-style base. The present invention is distinguished from this prior art in that it uses the reflected shape of the object in the seats on the mounting, which enables the mounting to function safely with a much smaller restraint. Further, the present claimed invention utilizes reflected shapes in the lower support on the object, allows for multiple types of support mechanisms, and provides tolerance in all contact areas. U.S. Pat. No. 5,090,217, issued Feb. 25, 1992 to Beber et al., also seeks to increase visibility of a gemstone and increase the safety of setting a stone. The claimed invention is distinguished from this prior art in that the prior art is limited to gemstones with pointed tips and requires one prong per tip on the stone. The present invention, in contrast, may be applied to multiple object shapes and does not require a point of contact at each point on the object. Further, the prior art does not employ the object's reflected shape in the seats of the mounting, which is the definitive characteristic of the present invention.

Another aspect of the claimed invention is its preferred process of designing and manufacturing. The claimed invention discloses a manufacturing method based on CAD/CAM and using an electronic description of the surface geometry of an object. Electronic descriptions of this type have been used in the industry for the purpose of analyzing the quality of an object in the pursuit of valuation. Using such an electronic description to design the interior surfaces of a mounting is novel to the claimed invention.

Other inventions, such as U.S. Pat. No. 4793045, issued Dec. 27, 1988 to Singer, have disclosed other methods to create a mounting based on the shape of an object. The claimed invention is distinguished from this prior art in that the prior requires casting a replica of the object prior to creating the mounting. The present invention does not require a casted replica of the object, and can be manufactured through CAD/CAM technology with only an electronic description of the object. An artisan can thus create a mounting for an object without physical possession of the object. Further, the prior art is limited to a bezel style mounting which fully encloses the object, while the present invention is adaptable to any style of mounting and utilizes matched shapes and sizes of surfaces on the upper and lower portion of the object at surfaces selected by the artisan as points of contact. Further, the claimed invention allows tolerance in the fit between the object and the mounting, thereby allowing for shrinkage and expansion of manufacturing materials and increasing the safety of the object within the mounting.

### BRIEF SUMMARY OF THE INVENTION

The claimed invention includes a mounting for containing an object and a method for designing and manufacturing said mounting. In its preferred embodiment, the present invention functions as an article of personal jewelry. In its alternate preferred embodiment, it functions as a free-standing or suspended display device. The invention is not limited to these applications; it may be applied in any circumstance where the aim of a skilled worker is to contain, secure, support, or display an object.

It is an object of the invention to provide a new and improved mounting for objects.

It is an object of the invention to provide a new and improved mounting for objects with mounting surfaces whose shapes and dimensions match the shapes and dimensions of selected surfaces of a specific object.

It is an object of the invention to provide a new and improved mounting for an object which allows more visibility of an object set within a mounting.

It is an object of the invention to provide a new and improved mounting for objects which allows skilled industry workers to set an object more securely and with less risk of damaging the object during the setting process.

It is an object of the invention to disclose a method for using the surface geometry description of an object to select and design interior surfaces of mounting seats for that object.

Mountings rely on multiple points of support and restraint which collectively contain an object within a mounting. The claimed invention replicates the shapes and dimensions of the object's surfaces onto the contact surfaces in the seats of the object's mounting. In particular, the claimed invention utilizes mounting surfaces whose contours match the contours of the object contained within the mounting.

The claimed invention utilizes at least one restraining point of contact on an upper section of the object, such as the portion above the girdle of a faceted gemstone. The claimed invention also utilizes one or more supporting point of contact on a lower portion of the object, such as the pavilion of a faceted gemstone. Note, however, that the claimed invention is not limited to use with faceted gemstones. The claimed invention allows for tolerance in the fit between the object and the mounting so that the mounting will not create excessive and potentially damaging pressure at critical points on the object.

### BRIEF DESCRIPTION OF THE SEVERAL VIEWS OF THE DRAWING

Illustration 1 shows the top elevation of the claimed invention in its preferred embodiment as a jewelry mounting for a gemstone to be worn as jewelry.

Illustration 2 shows the side elevation of the claimed invention in the same embodiment as Illustration 1.

Illustration 3 shows the seat of the claimed invention with prong-style restraints in its preferred embodiment.

Illustration 4 illustrates one mechanism for providing tolerance in the fit between the mounting and the object.

Illustration 5 demonstrates the claimed invention in its preferred embodiment as a jewelry mounting which utilizes a bezel mounting.

Illustrations 6 and 7 demonstrate the claimed invention in its preferred embodiment using a single upper restraint and a single lower support.

### DETAILED DESCRIPTION OF THE INVENTION

The claimed invention includes a mounting intended to contain and display an object in an article of the designer's choice and discloses the preferred process for creating it. The preferred embodiment of the claimed invention is as an article of jewelry. The alternate preferred embodiment is as a free-standing or suspended display device. These embodiments should not be taken as the full range of applications for the claimed device. There are many mountings in current technology which have the same purpose as the claimed invention. The claimed invention is an improvement over current technology because it creates a mounting that is more secure and stable, requires less time of a skilled worker to assemble a completed article, holds an object more safely, and allows for more of the object to be seen by observers.

The claimed invention is based on inversely replicating the geometry of selected surfaces of a contained object. The mirror image of the object leads to the definition of the surfaces in the mounting which will support and restrain the object. The space within the mounting is all or part of the negative image of the object. Inverse replication creates inverse symmetry between the geometry of the object and the geometry of the mounting. The shapes and dimensions of mounting surfaces match all or part of the shapes and dimensions of surfaces of the object. The benefits of the claimed invention derive from this symmetry. Mountings of current technology do not exhibit this symmetrical geometry inside mounting heads and thus do not offer the benefits available through the claimed invention. Mountings of current technology utilize a variety of mechanisms to contain an object, including but not limited to prongs, channels, and bezels. In any embodiment, the claimed invention allows for tolerance in the fit between the mounting and the object so that no pressure is exerted on the surface junctions, such as facet edges of a gemstone, during the setting process.

The claimed invention utilizes one or more restraints on the upper portion of the object and one or more supports on the lower portion of the object. A restraint on the top portion may be joined to a support on the bottom of the object. Any restraint or support of the claimed invention will include interior surfaces which mirror the surfaces of the object, wherein each mounting surface contacts a single corresponding surface on the object. In the example of a gemstone, a mounting seat will utilize planar surfaces each of which is coplanar with and fully or partially contacts a selected facet on the gemstone. The claimed invention is distinguished from mountings of current technology in that interior surfaces in current technology do not mirror the surfaces of the object; instead, a single mounting mechanism such as a prong may contact the junction between surfaces, such as the edge between adjacent facets, resulting in contact pressure at those junctions. Skilled professionals in the industry will recognize that such pressure is a significant cause of damage that occurs during the setting of an object. In contrast, the interior surfaces of mounting seats in the claimed invention will be coplanar and parallel to the surfaces of the gemstone, and provide a tolerance mechanism which prevents application of setting pressure on facet edges.

Because mounting seats of the claimed invention precisely match surfaces of an object, they provide equal or better security of the object in the mounting while requiring smaller supports and restraints. Thus, the present invention allows more of the object to be viewed while in the mounting.

In any embodiment of the claimed invention, the exact dimensions of the claimed invention will depend upon the size of the object and the worker's artistic design for the mounting. In the invention's preferred embodiment as jewelry with a faceted gemstone, at least one upper restraint would extend to cover at least one-third of the crown, which is the portion of the object above its largest perimeter, the girdle. At least one lower support must be present; the size and shape of this support depend on the designer's choices. Varying degrees of assembly are also possible, in which pieces might be temporarily or permanently joined together. An example is the case of a bezel mounting, in which the mounting is manufactured in two parts as a base and a cover, then semi-permanently or permanently joined with the body of a piece of jewelry or personal adornment. Other examples of temporary joining include screwing, locking, or gluing. The specific size of a finished article is not definitive of the claimed invention. The distinctions of the claimed invention are the use of contact surfaces in the mounting that contact and correspond to the surfaces of the object, and the provision of tolerance at surface junctions to prevent mounting pressure.

The preferred process of manufacturing the claimed invention utilizes computer-aided design/machining (CAD/CAM). This technology offers increased precision in both designing and manufacturing, and thus affords the highest possible correspondence between the surfaces of the object and the mounting. In the preferred process, the designer imports the electronic surface geometry description into CAD software or creates it within CAD software, and uses the definition to identify points on the object where restraints and supports will be employed. This profile of an object, such as a gemstone, includes the object's definition in terms of shape and dimensions, but not color or texture or other CAD attributes. A file of type STL (STereroLithography) is an example of such an electronic definition. STL files and similar files are used in the industry to analyze quality characteristics of gemstones and to aid in the general design of mountings. This utilization of a surface geometry description is new to the claimed invention; the industry such descriptions with CAD software to create the peripheral artistic design of mountings. The present invention discloses a method which utilizes such files as the starting point for designing the interior surfaces of a mounting. An electronic profile can be defined explicitly in CAD technology or can be obtained by measuring the object in a device which creates an electronic profile that is compatible with CAD/CAM technology, such as a device which generates an STL or similar type file. The claimed invention supports surface geometry descriptions of objects created in large quantity to a certain specification, such as mass-produced gemstones or other ornamental objects. The present invention also supports objects cut to unique measurements and shapes, such as fantasy-cut or special cut gemstones.

Skilled workers in the industry are familiar with the procedures required to ensure that a manufactured item meets the size dimensions required for a specific object, including the exact steps to use CAD and CAM technology and the techniques required to account for shrinkage or expansion of materials used in the manufacturing process.

Serial photography is an example of a process which is external to CAD/CAM but which can produce a compatible definition. Due to the number of photographs required and the tedious nature of compiling them, this is not the preferred process. Similarly, processes exist which manually create a replica of object surfaces within the mounting are available, such as manually carving a wax. Although the resulting device falls within the claims of the claimed invention, this is not the preferred or disclosed process.

Regardless of the procedure used to obtain the object's profile and definition, the claimed invention uses the geometric description file to define points of contact which mirror and correspond to selected surfaces of an object. The definition can be electronically stored and then used with CAM technology to manufacture a mounting or to produce a model which is subsequently used in standard industry processes to manufacture a mounting. Examples of computer-assisted manufacturing processes include striking, pressing, milling, three-dimensional printing, and manufacturing with composite materials such as powdered metals. Manufacturing the claimed invention outside of CAM may be achieved through a variety of techniques available individually or in combination to skilled workers, including but not limited to casting and the use of precious metal clay.

Illustration 1 shows the top elevation of the claimed invention in its preferred embodiment as a mounting for a gemstone to be worn as jewelry. This embodiment includes two visible upper restraints on the upper portion of the gemstone (the crown) and 4 hidden supports on the lower portion of the gemstone (the pavilion). As the supports are not visible in the top viewing position, they are illustrated in hidden lines in Illustration 1. Two of the lower supports connect with the visible upper restraints, to which they are structurally joined. Two of the lower supports, indicated by hidden lines in Illustration 1, do not join to upper restraints. The claimed invention requires at least one upper restraint and at least one lower support. The restraints and supports may be rib-like members as illustrated in this illustration, or might enclose the perimeter of an object, as illustrated by the tubular restraint in Illustration 5. Illustration 1 further illustrates, in hidden lines, the location of the base of this embodiment.

Illustration 2 shows the side elevation of the claimed invention in the same embodiment as Illustration 1. In Illustration 2, the upper restraints of Illustration 1 are visible, as well as the lower supports connected to said upper restraints. A portion of the gemstone is obstructed by the visible restraint/support combination, and that obstructed portion is shown in hidden lines in Illustration 2. The base of this embodiment is visible in Illustration 2. The restraints are constructed so as to lie in planes parallel to the planes of the gemstone. The facets of the gemstone define these planes.

Illustration 3 shows the mounting seat from one upper restraint of the invention as embodied in Illustrations 1 and 2, in which the invention utilizes prong-style restraints and supports to contain a round brilliant faceted gemstone. Illustration 3 illustrates that the inside mounting surfaces of the seat correspond to the shape and dimension of the gemstone to be displayed. In this illustration, the interior surfaces of the seat correspond to facets on the girdle and crown of a round-cut gemstone. In this embodiment, the mounting surfaces are recessed and the facets of the gemstone fit into the recessed area. The shape and size of these areas are to be defined at the designer's discretion during the preferred process of manufacturing. In the finished article, these areas will reflect all or part of the shape and size of selected surfaces on the object.

Illustration 4 shows one embodiment of tolerance in the claimed invention. The invention allows but does not require tolerance at any location where an object could incur stress from the pressure of the mounting. Such points include surfaces (facets) or junctions between surfaces (facet edges) on the displayed object. The tolerance avoids direct pressure by the mounting on surfaces or surface junctions and thus provides one of the main benefits of the claimed invention. The claimed invention may comprise such tolerance at any surface or at any point where object surfaces meet, including but not limited to crown facets, crown facet junctions, crown-to-girdle junctions, girdle-to-pavilion junctions, pavilion-to-culet junctions, and the culet. The exact shape and depth of tolerance is determined at the designer's discretion during the preferred manufacturing process. Tolerance may be allowed wherever two or more surfaces meet on the object.

Illustration 5 illustrates the claimed invention embodied as a jewelry mounting utilizing a bezel-style restraint and support. The rim of the bezel is visible. The interior wall of the bezel tube is illustrated in hidden lines. A portion of the gemstone is visible and the remainder of the gemstone is illustrated in hidden lines. The bezel contacts the perimeter of the object in two locations, one as a support below the girdle (Ill. 3a) and one as a restraint above the girdle (Ill. 3c). Illustration 3 also illustrates the seat of the bezel-style embodiment (Ill. 3b) wherein the bezel wraps from the crown to the girdle to the pavilion. In this embodiment the base of the mounting is the bottom of the bezel tube.

Illustrations 6 and 7 demonstrate the minimal embodiment of the claimed invention, utilizing a single restraint on the upper portion of the object and a single support on the lower portion of an object. The upper restraint, illustrated at Point 6a/7a is a prong-style restraint and is applied to the upper portion of the object, which is the crown of the gemstone. The lower support is similar to the bezel tube shown in Illustration 5. Point 6b/7b identifies the outer edge of the upper portion of the object, the table of a faceted jewel. Point 6c/7c shows the outer edge of the single support. The support is positioned on the lower portion of the object, which is the pavilion of a faceted jewel, and the support contacts a full perimeter of the pavilion. Point 6d/7d shows the outermost perimeter of the object, the girdle of a faceted jewel. The girdle is the division between the upper and lower portions of the object. Point 6e/7e is the innermost edge of the lower support. In both illustrations, the distance between c and e is the thickness of the support itself, in this embodiment the thickness of the bezel tube wall.

The inventors claim the following:

1. A device for containing and/or displaying an object, comprising: a plurality of supports and restraints, each comprising one or more points of contact between said object and said device, said points of contact having shapes and dimensions geometrically similar to selected surfaces of said object, so that the contours of the device form all or part of the mirror image of said object;

2. The device set forth in claim 1, wherein: one or more support is placed below the widest perimeter of said object, thereby stabilizing said object within said device;

3. The device set forth in claim 1, wherein: one or more restraint is placed above the widest perimeter of said object, serving to restrain said object within said device;

4. The device set forth in claim 1, wherein: one or more support is connected to a restraint to form a continuous support-restraint member;

5. The deice set forth in claim 1, wherein: a plurality of contact surfaces collected in a group forms a support or restrain, in which said contact surfaces geometrically reflect the corresponding surfaces of the object;

6. The device set forth in claim 1, wherein: the shape of the device allows tolerance relative to the shape of the object, so that surfaces or surface junctions of the object do not incur direct pressure from corresponding surfaces of the device;

7. The device set forth in claim 1, wherein: a completed article comprises a plurality of the device.

8. The device set forth in claim 1, wherein: the device is designed and created

9. A method of designing and manufacturing a mounting device whose supports and restraints comprise surfaces which correspond in shape and size to surfaces of an object to be contained within the mounting device, comprising:
a. importing an electronic description of the surface geometry of said object into elements of computer-aided design (CAD) technology;
b. identifying within the CAD technology the region or regions of the object which will serve as points of contact with said mounting device;
c. isolating the surface geometry of said regions;
d. designing one or more supports or restraints of a mounting device based on the mirror image of said surface geometry;
e. incorporating said restraints or supports into a complete mounting subject to a designer's discretion
f. creating an electronic definition of said complete mounting;
g. using said electronic definition with computer-aided machining (CAM) processes to produce said mounting or a model of said mounting to be used for production by industry-standard processes.
